(19) United States
(12) Patent Application Publication
(10) Pub. No.: US 2007/0000401 A1
(43) Pub. Date: Jan. 4, 2007

(54) Sheet pressing apparatus

(76) Inventors: Hiromichi Shimokawa, Ibaraki (JP); Takanobu Aoki, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/449,437

(22) Filed: Jun. 7, 2006

(30) Foreign Application Priority Data
Jun. 16, 2005 (JP) 176121/2005

(51) Int. Cl. B41F 13/64

(52) U.S. Cl. 101/240

(57) ABSTRACT

A sheet pressing apparatus includes a cam, lever, sheet press member, and first and second compression coil springs. The cam has a cam surface and is supported rotatably. The lever supports a cam follower that abuts against the cam surface and is pivoted by rotation of the cam. The sheet press member is movably supported by the lever and moves between a sheet press position to press a stacked sheet and a retreat position retreated from the sheet press position in accordance with swing motion of the lever. The first and second compression coil springs are arranged between the lever and a support, and bias the lever to bring the cam follower into tight contact with the cam surface. The second compression coil spring has a biasing force larger than that of the first compression coil spring. When the sheet press member is located at the sheet press position, only the first compression coil spring biases the cam follower with respect to the cam surface. When the sheet press member is located at the retreat position, the first and second compression coil springs cooperate to bias the cam follower with respect to the cam surface.

### BACKGROUND OF THE INVENTION

The present invention relates to a sheet pressing apparatus used by a feed device or the like in a sheet-fed offset rotary printing press and, more particularly, to a sheet pressing apparatus in which a sheet press member moves between a sheet press position to press a stacked sheet and a retreat position retreated from the sheet press position.

A sheet pressing apparatus in a conventional sheet-fed offset rotary printing press comprises a rotatably supported cam, a cam follower which abuts against the cam surface of the cam, a lever which is moved by rotation of the cam, a sheet press member which is supported by the lever and can be moved between a sheet press position to press a stacked sheet and a retreat position retreated from the sheet press position by rotation of the cam, and a biasing means which is arranged between the lever and a support member to bias the lever so as to bring the cam follower into tight contact with the cam surface.

In the conventional sheet pressing apparatus described above, the cam follower is brought into tight contact with the cam surface by one biasing means. If the biasing force of the biasing means increases, the pressing force to press the sheet increases excessively, so the sheet press member may damage the sheet. If the biasing force of the biasing means decreases, the tight-contact force of the cam follower with respect to the cam surface becomes insufficient. Particularly, when the cam follower moves from a large-diameter portion to a small-diameter portion, the cam follower cannot follow the cam surface but separates from it, causing so-called cam detachment.

### SUMMARY OF THE INVENTION It is an object of the present invention to provide a sheet pressing apparatus which does not damage a sheet and prevents cam detachment.

In order to achieve the above object, according to the present invention, there is provided a sheet pressing apparatus comprising a cam having a cam surface and supported rotatably, a lever which supports a cam follower that abuts against the cam surface and is pivoted by rotation of the cam, a sheet press member which is movably supported by the lever and moves between a sheet press position to press a stacked sheet and a retreat position retreated from the sheet press position in accordance with swing motion of the lever, and first biasing means and second biasing means, arranged between the lever and a support member, for biasing the lever so as to bring the cam follower into tight contact with the cam surface, the second biasing means having a biasing force larger than that of the first biasing means, wherein when the sheet press member is located at the sheet press position, only the first biasing means biases the cam follower with respect to the cam surface, and when the sheet press member is located at the retreat position, the first biasing means and the second biasing means cooperate to bias the cam follower against the cam surface.

### BRIEF DESCRIPTION OF THE DRAWINGS

FIG. 1 is a front view of a sheet pressing apparatus according to the present invention;

FIG. 2 is a side view of the sheet pressing apparatus according to the present invention to show a state wherein a sheet press member is positioned at a sheet press position to press a sheet;

FIGS. 3A and 3B are side views for explaining the operation of the sheet pressing apparatus according to the present invention, in which FIG. 3A shows a state wherein the sheet press member is switched between the sheet press position and a retreat position, and FIG. 3B shows a state wherein the sheet press member is positioned at the retreat position; and

FIG. 4 is a view for explaining a state in the sheet pressing apparatus according to the present invention wherein the tight-contact force of a cam follower which is in contact with a cam surface is switched.

### DESCRIPTION OF THE PREFERRED EMBODIMENTS

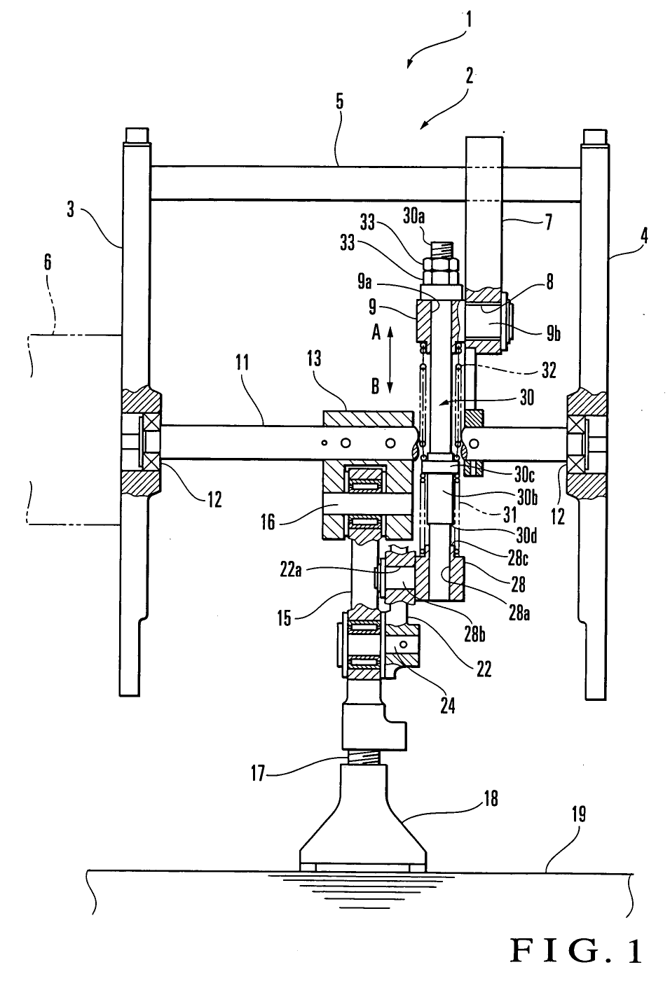

A sucker device in a sheet-fed offset rotary printing press according to an embodiment of the present invention will be described with reference to FIGS. 1 to 3B.

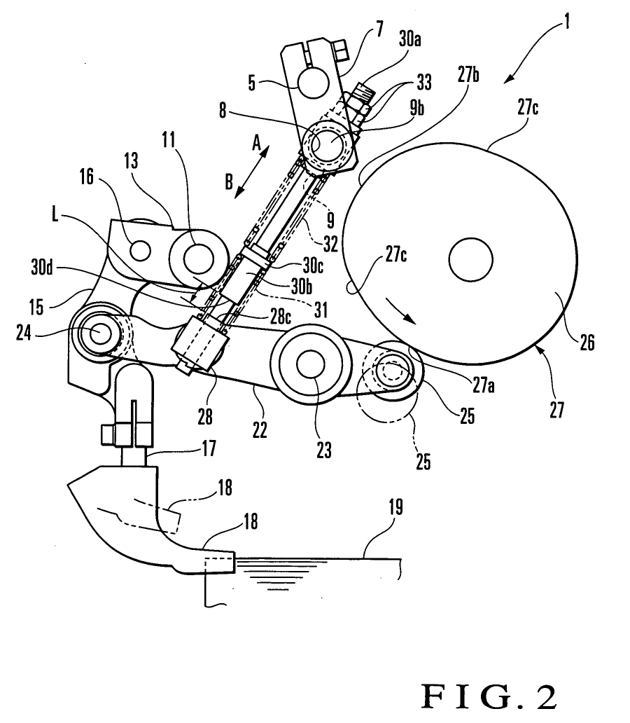

As shown in FIG. 1, a sheet pressing apparatus 1 comprises a sucker frame 2 including side plates 3 and 4 which oppose each other and a rod 5 horizontally extending between the side plates 3 and 4. The side plate 3 is attached to the frame (not shown) of a feed device through a bracket 6. A support 7 (support member) has one end fixed to the rod 5. The other end of the support 7 has a support hole 8 (FIG. 2).

A shaft portion 9b integrally projecting from a spring retainer 9 having a through hole 9a is pivotally supported by the support hole 8 of the support 7 which engages with the spring retainer 9. A rotating shaft 11 is rotatably supported between the two side plates 3 and 4 of the sucker frame 2 through bearings 12. A swingable member 13 having one end which is axially mounted is supported by the rotating shaft 11 to be swingable about the rotating shaft 11 as a swing center. A connecting member 15 is pivotally mounted on the other end of the swingable member 13 through a shaft 16. A sheet press member 18 is attached to the other end of the connecting member 15 through a screw 17. The sheet press member 18 is supported such that it can move between the sheet press position (the solid line in FIG. 2) to press a stacked sheet 19 and a retreat position (the alternate long and two short dashed line in FIG. 2) retreated from the sheet press position when a cam 26 rotates, as will be described later.

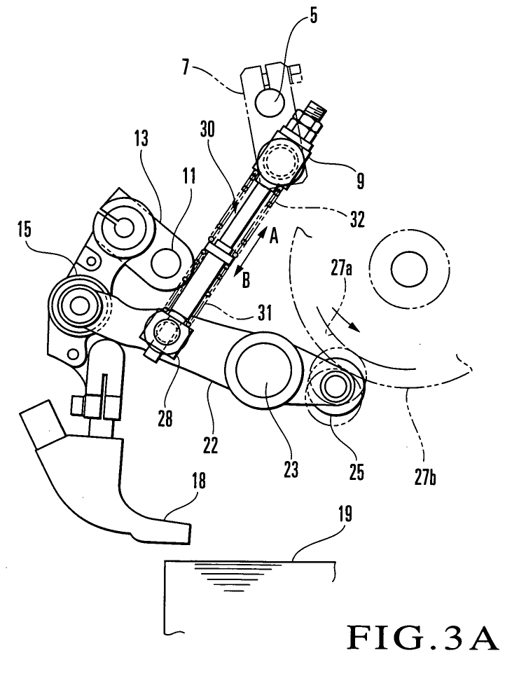

The center of a lever 22 is rotatably supported between the two side plates 3 and 4 of the sucker frame 2 through a shaft 23 (FIGS. 3A and 3B). The center of the connecting member 15 is pivotally mounted on one end of the lever 22 through a pin 24. A cam follower 25 is pivotally mounted on the other end of the lever 22. The cam follower 25 is brought into tight contact with a cam surface 27 of the rotating cam 26 by the spring forces of first and second compression coil springs 31 and 32 (first and second biasing means). The cam surface 27 of the cam 26 is formed of a small-diameter portion 27a as an iso-circular low cam, a large-diameter portion 27b as an iso-circular high cam, and an inclined portion 27c which links the small-diameter portion 27a to the large-diameter portion 27b.

A first spring retainer 28 having a through hole 28a is pivotally supported by a support hole 22a, formed in the lever 22 between the shaft 23 and pin 24, through a shaft portion 28b integrally projecting from the first spring retainer 28. An engaging surface 28c is formed on that end face of the first spring retainer 28 which is in the direction of an arrow A (a direction to come close to the rod 5). A thin elongated shaft 30 has a threaded portion 30a at its one end and a large-diameter portion 30b at its intermediate portion. The large-diameter portion 30b has a flange 30c at its one end and a step 30d at its other end.

The shaft 30 has one end slidably supported by a through hole 9a of a second spring retainer 9 and the other end slidably supported by the through hole 28a of the first spring retainer 28. The step 30d of the shaft 30 opposes the engaging surface 28c of the first spring retainer 28 at a predetermined gap. The engaging portion 28c of the first spring retainer 28 and the step 30d of the shaft 30 form an engaging means.

The first compression coil spring 31 is elastically mounted between the flange 30c of the shaft 30 and the first spring retainer 28. The second compression coil spring 32 is elastically mounted between the flange 30c and the second spring retainer 9. Hence, the shaft 30 is biased from the second spring retainer 9 by the spring force of the second compression coil spring 32 in the direction of an arrow B. Simultaneously, the shaft 30 biases the first spring retainer 28 in the direction of the arrow B (a direction to separate from the rod 5) with the spring force of the first compression coil spring 31.

The spring force of the first compression coil spring 31 is set smaller than that of the second compression coil spring 32. The spring force of the first compression coil spring 31 is set to such a level that when the sheet press member 18 is located at the sheet press position to press the stacked sheet 19, the sheet press member 18 will not deform the sheet 19. The spring force of the second compression coil spring 32 is set to such a level that when the sheet press member 18 moves from the retreat position retreated from the sheet press position to the sheet press position, the cam follower 25 does not separate from the cam surface 27 of the cam 26.

As a double nut 33 (stopper member) threadably engaging with the threaded portion 30a engages with the second spring retainer 9, it regulates movement in the direction of the arrow B of the shaft 30 biased by the spring force of the second compression coil spring 32. When the threadable engaging amount of the double nut 33 with respect to the threaded portion 30a is adjusted, the gap between the second spring retainer 9 and the flange 30c of the shaft 30 is adjusted, so the spring force of the second compression coil spring 32 with respect to the shaft 30 can be adjusted.

When the cam follower 25 is in contact with the small-diameter portion 27a of the cam 26, the lever 22 pivots counterclockwise in FIG. 2 about the shaft 23 as a center to form a gap L between the engaging surface 28c of the first spring retainer 28 and the step 30d of the shaft 30. Therefore, the shaft 30 does not move until the first spring retainer 28 has moved for the gap “L” in the direction to come close to the step 30d.

In this state, the biasing force in the direction of the arrow B against the first spring retainer 28 consists of only the spring force of the first compression coil spring 31 elastically mounted between the flange 30c and second spring retainer 9. Thus, the lever 22 is also biased counterclockwise about the shaft 23 as a center by the spring force of the first compression coil spring 31.

When the cam follower 25 is in contact with the small-diameter portion 27a of the cam 26, the sheet press member 18 is located at the sheet press position to press the stacked sheet 19 through the connecting member 15, as shown in FIG. 2. When the cam follower 25 is in contact with the large-diameter portion 27b of the cam 26, the lever 22 is biased clockwise in FIG. 2 about the shaft 23 as a center against the spring force of the compression coil spring 32. Thus, the connecting member 15 pivots clockwise through the swingable member 13 about the rotating shaft 11 as a center to position the sheet press member 18 at the retreat position (FIG. 3B) retreated from the sheet press position.

The operation in the sheet pressing apparatus having the above arrangement in which the sheet press member moves between the sheet press position and retreat position will be described.

When the cam 26 rotates and the cam follower 25 comes into contact with the small-diameter portion 27a of the cam surface 27, the sheet press member 18 is located at the sheet press position to press the stacked sheet 19, as indicated by the solid line in FIG. 2. At this time, the engaging surface 28c of the first spring retainer 28 is spaced apart from the step 30d of the shaft 30 by the gap L, and no gap is formed between the compression coil spring 32 and second spring retainer 9.

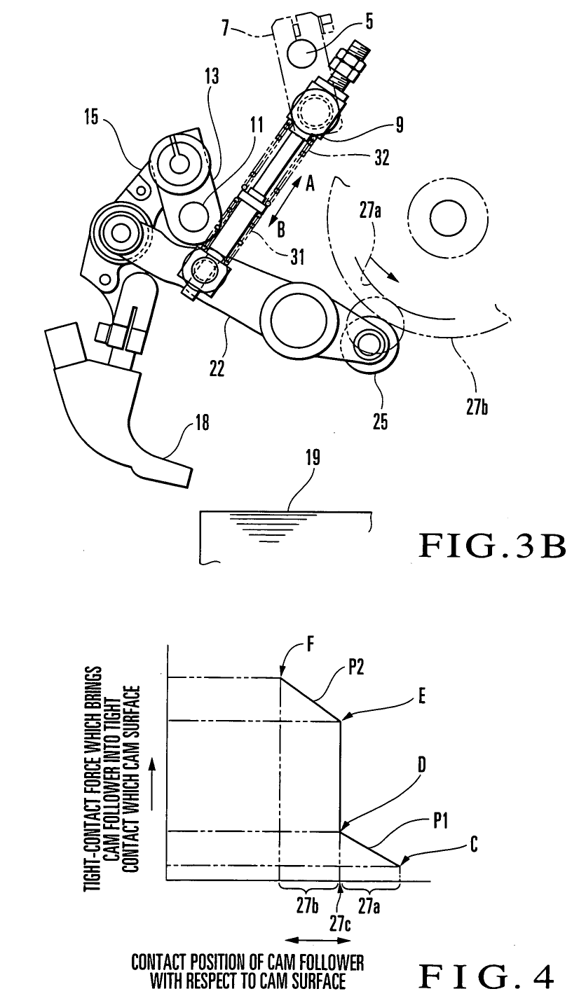

As the spring force of the second compression coil spring 32 is set larger than that of the first compression coil spring 31, the shaft 30 is inhibited by the spring force of the second compression coil spring 32 from moving in the direction of the arrow A, and the first spring retainer 28 becomes movable in the direction of the arrow A against the spring force of the first compression coil spring 31. Therefore, while the cam follower 25 is in contact with the small-diameter portion 27a, the biasing force (the tight-contact force of the cam follower 25 in contact with the cam surface 27) that the lever 22 receives through the first spring retainer 28 takes a minimal value of a tight-contact force P1 obtained by the spring force of only the first compression coil spring 31, as indicated by a point C in FIG. 4.

According to this embodiment, the spring force of the first compression coil spring 31 is set to such a level that when the sheet press member 18 is located at the sheet press position to press the stacked sheet 19, the sheet press member 18 does not deform the sheet 19. Hence, the sheet press member 18 does not deform the sheet or damage the surface of the sheet.

In this state, when the cam 26 further pivots and the cam follower 25 exceeds the small-diameter portion 27a and comes into contact with a slightly high cam before reaching the inclined portion 27c, the sheet press member 18 is located between the sheet press position indicated by the solid line and the position indicated by the alternate long and two short dashed line in FIG. 2. At this time, the gap between the engaging surface 28c of the first spring retainer 28 and the step 30d of the shaft 30 becomes smaller than L, and no gap is formed between the double nut 33 and second spring retainer 9. In this state, the biasing force that the lever 22 receives through the first spring retainer 28 is the tight-contact force P1 from the point C to a point D in FIG. 4 which is obtained by the spring force of only the first compression coil spring 31.

In this state, when the cam surface 27 further pivots and the cam follower 25 comes into contact with the inclined portion 27c, the lever 22 pivots clockwise about the shaft 23 as a center against the spring force of the first compression coil spring 31. Thus, the first spring retainer 28 moves in the direction of the arrow A so the engaging portion 28c engages with the step 30d of the shaft 30. Therefore, the gap between the engaging surface 28c of the first spring retainer 28 and the step 30d of the shaft 30 disappears, and no gap is formed between the double nut 33 and second spring retainer 9. In this state, as indicated by the point D in FIG. 4, the biasing force that the lever 22 receives through the first spring retainer 28 takes a maximal value of the tight-contact force P1 obtained by the spring force of only the first compression coil spring 31. At this time, the sheet press member 18 is located at the position shown in FIG. 3A.

After the engaging portion 28c engages with the step 30d of the shaft 30, when the cam 26 further rotates, the cam follower 25 comes into contact with a cam slightly higher than the inclined portion 27c. Then, the shaft 30 moves in the direction of the arrow A together with the first spring retainer 28, and a slight gap is formed between the double nut 33 and second spring retainer 9. Thus, the spring force of the second compression coil spring 32 is applied to the shaft 30. The biasing force that the first spring retainer 28 receives is a tight-contact force P2 as the sum of the spring force of the first compression coil spring 31 and the spring force of the second compression coil spring 32.

When the cam 26 further rotates and the cam follower 25 comes into contact with the cam 26 between the inclined portion 27c and large-diameter portion 27b, the sheet press member 18 is located between the position shown in FIG. 3A and the position shown in FIG. 3B. In this state, no gap is formed between the engaging surface 28c of the first spring retainer 28 and the step 30d of the shaft 30, while a gap is formed between the double nut 33 and second spring retainer 9. Thus, the tight-contact force which brings the cam follower 25 into tight contact with the cam surface 27 is the tight-contact force P2 from the point E to a point F in FIG. 4.

When the cam 26 further rotates and the cam follower 25 comes into contact with the large-diameter portion 27b of the cam 26, the sheet press member 18 is located at the retreat position shown in FIG. 3B. In this state, no gap is formed between the engaging surface 28c of the first spring retainer 28 and the step 30d of the shaft 30, while a gap is formed between the double nut 33 and second spring retainer 9. Thus, as indicated by the point F in FIG. 4, the tight-contact force P2 which brings the cam follower 25 into tight contact with the cam surface 27 reaches a maximal value.

According to this embodiment, the spring force of the second compression coil spring 32 is set to such a level that when the sheet press member 18 is moved from the retreat position in the direction so as to be located at the sheet press position, the cam follower 25 does not separate from the cam surface 27 of the cam 26. Hence, cam detachment can be prevented while the cam follower 25 is in contact with the large-diameter portion 27b.

As described above, as the cam 26 rotates, the lever 22 pivots clockwise about the shaft 23 (FIG. 2) as a center, and the tight-contact force of the sheet press member 18 shifts from the point C to the point F in FIG. 4. After that, when the cam 26 further rotates, the lever 22 pivots counterclockwise about the shaft 23 as a center, and the tight-contact force of the sheet press member 18 shifts from the point F to the point C in FIG. 4. In this manner, when the cam 26 continues rotating in one direction, the mode in which the tight-contact force shifts from the point C to the point F and the mode in which the tight-contact force shifts from the point F to the point C are repeated.

As the sheet 19, various types of sheet-type objects can be used, e.g., paper or a foil-type sheet, an aluminum sheet, or the like.

As has been described above, according to the present invention, when the sheet press member is located at the sheet press position, it presses the sheet with the first biasing force which is a small biasing force. Thus, the sheet press member does not damage the surface of the sheet. When the sheet press member is located at the retreat position, the second biasing force which is a large biasing force and the first biasing force bring the cam follower into tight contact with the cam surface. Thus, cam detachment in which the cam follower separates from the cam surface can be inhibited.

What is claimed is:

1. A sheet pressing apparatus comprising:
a cam having a cam surface and supported rotatably;
a lever which supports a cam follower that abuts against said cam surface and is pivoted by rotation of said cam;
a sheet press member which is movably supported by said lever and moves between a sheet press position to press a stacked sheet and a retreat position retreated from the sheet press position in accordance with swing motion of said lever; and
first biasing means and second biasing means, arranged between said lever and a support member, for biasing said lever so as to bring said cam follower into tight contact with said cam surface, said second biasing means having a biasing force larger than that of said first biasing means, wherein
when said sheet press member is located at the sheet press position, only said first biasing means biases said cam follower biases cam follower with respect to said cam surface, and
when said sheet press member is located at the retreat position, said first biasing means and said second biasing means cooperate to bias said cam follower with respect to said cam surface.

2. An apparatus according to claim 1, further comprising a shaft having one end swingably supported by said lever and the other end slidably supported by said support member,
wherein said first biasing means constantly applies a biasing force to said shaft, and
said second biasing means selectively applies a biasing force to said shaft.

3. An apparatus according to claim 2, further comprising engaging means which moves said shaft together with said lever against a spring force of said second biasing means when said lever moves against a spring force of said first biasing means.

4. An apparatus according to claim 3, wherein
the spring force of said first biasing means is set to such a level that when said sheet press member is located at the sheet press position, said sheet press member does not deform the sheet, and
the spring force of said second biasing means is set to such a level that while said sheet press member moves from the retreat position to the sheet press position, said cam follower does not separate from said cam surface.

5. An apparatus according to claim 3, wherein said engaging means comprises
an engaging portion of said first spring retainer and
an engaging target portion which regulates movement of said engaging portion against a biasing force of said first biasing means with respect to said shaft.

6. An apparatus according to claim 5, wherein
said engaging portion and said engaging target portion are spaced apart from each other by a gap “L”, and
said shaft does not move until said engaging portion has moved by the gap “L” toward said engaging target portion.

7. An apparatus according to claim 2, further comprising
a first spring retainer which is supported by said lever to slidably support one end of said shaft,
a second spring retainer which is supported by said support member to slidably support the other end of said shaft, and
a flange portion formed on said shaft,
wherein said first biasing means comprises a first spring member elastically mounted between said flange portion and said first spring retainer, and
said second biasing means comprises a second spring member elastically mounted between said flange portion and said second spring retainer.

8. An apparatus according to claim 7, further comprising
an engaging target portion provided to said shaft between said flange portion and said first spring retainer, and
a stopper member provided to said shaft projecting from said second spring retainer,
wherein said cam surface comprises a small-diameter portion and a large-diameter portion,
when said cam follower comes into contact with said small-diameter portion of said cam surface, while said first spring retainer is separate from said engaging target portion and said second spring retainer is in contact with said stopper, said sheet press member is located at the sheet press position by only the biasing force of said first biasing means, and
when said cam follower comes into contact with said large-diameter portion of said cam surface, while said first spring retainer is in contact with said engaging target portion and said second spring retainer is separate from said stopper member, said sheet press member is located at the retreat position by the biasing forces of said first biasing means and said second biasing means.

9. An apparatus according to claim 8, wherein
when said cam follower comes into contact with said small-diameter portion of said cam surface, a minimal first tight-contact force generated by said first spring member is applied to said sheet press member,
when said cam follower comes into contact with an inclined portion between said small-diameter portion and large-diameter portion of said cam surface, a maximal second tight-contact force generated by said first spring member is applied to said sheet press member,
when said cam follower comes into contact with a cam surface portion which is slightly shifted from said inclined portion to said large-diameter portion of said cam surface, a third tight-contact force based on said first spring member and said second spring member is applied to said sheet press member,
when said cam follower comes into contact with said large-diameter portion of said cam surface, a maximal fourth tight-contact force generated by said first spring member and said second spring member is applied to said sheet press member, and
when said cam follower moves in sequential contact with said large-diameter portion to said small-diameter portion of said cam surface, the fourth to first tight-contact forces are sequentially applied to said sheet press member.

10. An apparatus according to claim 7, further comprising a stopper member which is provided to said shaft projecting from said second spring retainer and can adjust an axial position of said shaft.

11. An apparatus according to claim 7, wherein said first spring member and said second spring member comprise compression coil springs, respectively.
